(19) United States
(12) Patent Application Publication
(10) Pub. No.: US 2014/0175118 A1
(43) Pub. Date: Jun. 26, 2014

(54) DISPENSING ASSEMBLY FOR VENDING MACHINE

(71) Applicant: HON HAI PRECISION INDUSTRY CO., LTD., New Taipei (TW)

(72) Inventors: YUN-LUNG CHEN, New Taipei (TW); CHUNG CHAI, New Taipei (TW)

(73) Assignee: HON HAI PRECISION INDUSTRY CO., LTD., New Taipei (TW)

(21) Appl. No.: 13/962,093

(22) Filed: Aug. 8, 2013

(30) Foreign Application Priority Data
Dec. 20, 2012 (CN) 201210557655X

(51) Int. Cl. G07F 11/54

(52) U.S. Cl. CPC G07F 11/54
USPC 221/277

(57) ABSTRACT

A dispensing device includes a bracket, a base, and a tray. The base is rotatably mounted to the bracket and rotatable about a horizontal axis. A product may be placed on the base. The tray is located beneath the base and rotatable about a vertical axis. When the tray is rotated about the vertical axis to a first position, the tray supports the base thereby preventing the product from dropping down from the base. When the tray is rotated about the vertical axis to a second position, the tray releases the base, allowing the base to rotate about the horizontal axis and allowing the product to drop down from the base under the action of the gravity.

### BACKGROUND

1. Technical Field

The present disclosure relates to vending machines, and particularly to a dispensing assembly for a vending machine.

2. Description of Related Art

In many gravity type dispensing devices, a dispensing assembly for dispensing products includes a bracket, a tray, and a shaft. The bracket includes a base for placing the product thereon. The tray is located under the base. The tray is secured to the shaft. A motor rotates the shaft to hold or release the base. When the tray supports the base, the product is blocked. When the tray releases the base, the base rotates and the product can drop down into the accessible bin. Generally, the shaft is inserted in a plurality of shaft sleeves, and then the shaft sleeves are secured to the bracket by screws or latches. However, the securing process of the shaft is time-consuming, and a securing structure of the shaft can be complicated and costly. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a dispensing assembly.

FIG. 2 is an enlarged view of a circled portion II of FIG. 1.

FIG. 3 is an enlarged view of a circled portion III of FIG. 1.

FIG. 4 is similar to FIG. 3, but viewed from a different aspect.

FIG. 5 is an assembled, isometric view of the dispensing assembly of FIG. 1, with a shaft in an initial position.

FIG. 6 is similar to FIG. 5, but viewed from a different aspect.

FIG. 7 is another assembled, isometric view of the dispensing assembly of FIG. 1, with the shaft in a first position.

FIG. 8 is similar to FIG. 7, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

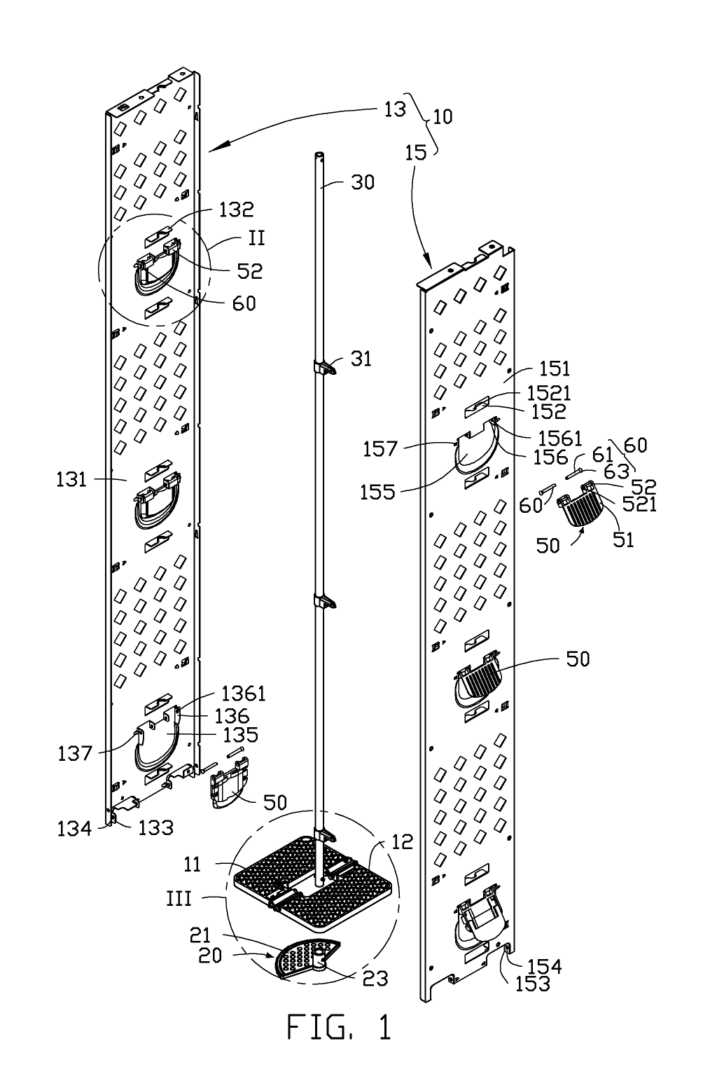

FIG. 1 shows one embodiment of a dispensing device. The dispensing device includes a bracket 10, a first base 11, a second base 12, a tray 20, a shaft 30, and a plurality of blocking plates 50.

The bracket 10 includes a first frame 13 and a second frame 15.

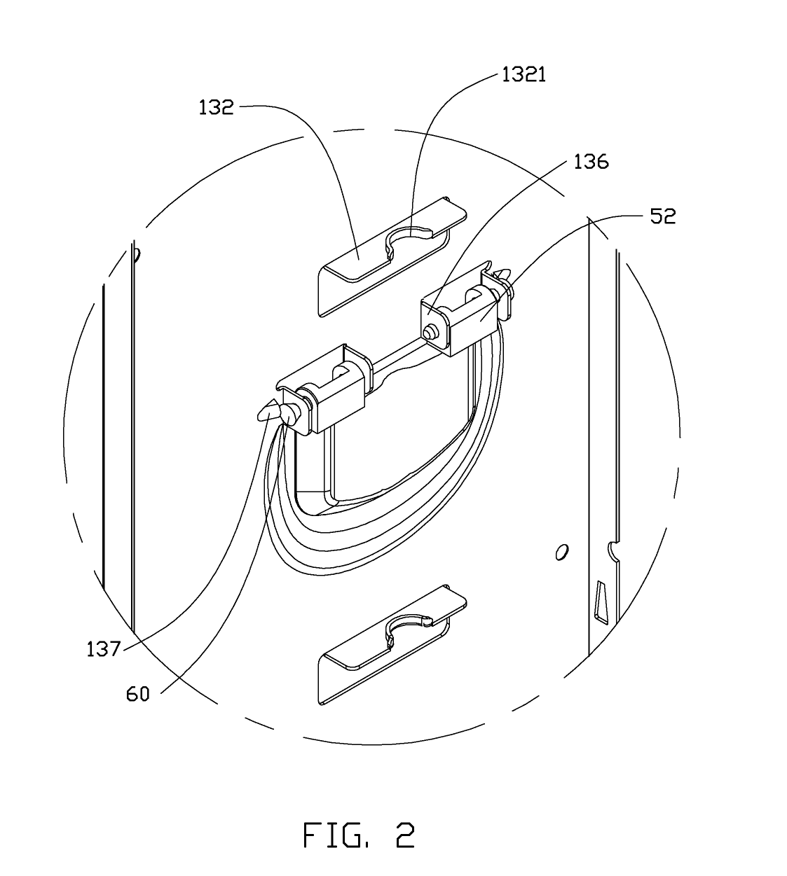

FIG. 1 and FIG. 2 show the first frame 13 of the embodiment. The first frame 13 includes a first mounting plate 131 and a plurality of first limiting pieces 132 extending from a side of the first mounting plate 131. Each first limiting piece 132 defines a first cutout 1321. Two pairs of first pivoting pieces 133 are positioned on a bottom end of the first mounting plate 131. Each first pivoting piece 133 is substantially perpendicular to the first mounting plate 131. Each first pivoting piece 133 defines a first pivoting hole 134. The first mounting plate 131 defines a plurality of first openings 135, and two pairs of first positioning pieces 136 extend from edges of each first opening 135. Each first positioning piece 136 defines a first positioning hole 1361. A first protrusion 137 extends from an outer surface of each first limiting piece 136. The first limiting pieces 132 are integrated with the first positioning pieces 136, the first pivoting pieces 133, and the first mounting plate 131. In one embodiment, the first cutout 1321 is semicircular.

The second frame 15 includes a second mounting plate 151 and a plurality of second limiting pieces 152 extending from a side of the second mounting plate 151. Each second limiting piece 152 defines a second cutout 1521. Two pairs of second pivoting pieces 153 are positioned on a bottom end of the second mounting plate 151. Each second pivoting piece 153 is substantially perpendicular to the second mounting plate 151. Each second pivoting piece 153 defines a second pivoting hole 154. The second mounting plate 151 defines a plurality of second openings 155, and two pairs of second positioning pieces 156 extend from the edges of each second opening 155. Each second positioning piece 156 defines a second positioning hole 1561. A second protrusion 157 extends from an outer surface of each second limiting piece 156. The second limiting pieces 152 are integrated with the second positioning pieces 156, the second pivoting pieces 153, and the second mounting plate 151. In one embodiment, the second cutout 1521 is semicircular.

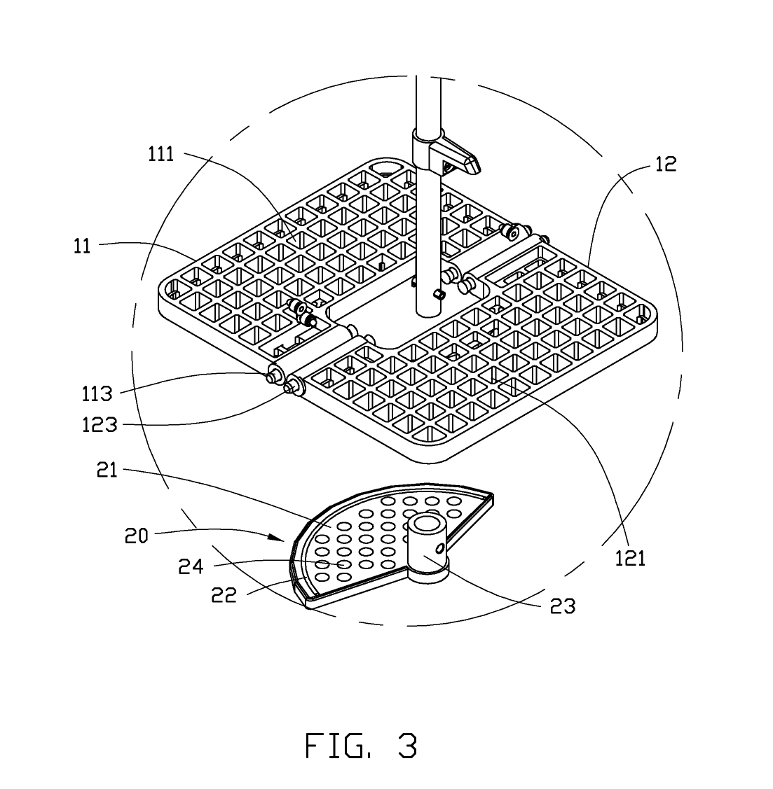

FIGS. 1 and 3 show the tray 20 including a support plate 21 and a mounting post 23 located on the support plate 21. In one embodiment, the support plate 21 is a circular sector with a central angle smaller than 180 degrees. An arc of the support plate 21 is formed with a plurality of sides of a regular polygon. For an instance, the arc of the support plate 21 is formed with ten sides of a 24-sided regular polygon and the central angle of the support plate 21 is 150 degrees. An arc-shaped boss 22 protrudes from an upper surface of the support plate 21. A central angle of the arc-shaped boss 22 is the same as the central angle of the support plate 21. The support plate 21 defines a plurality of convective orifices 24. The plurality of convective orifices 24 facilitates air convection through the support plate 21.

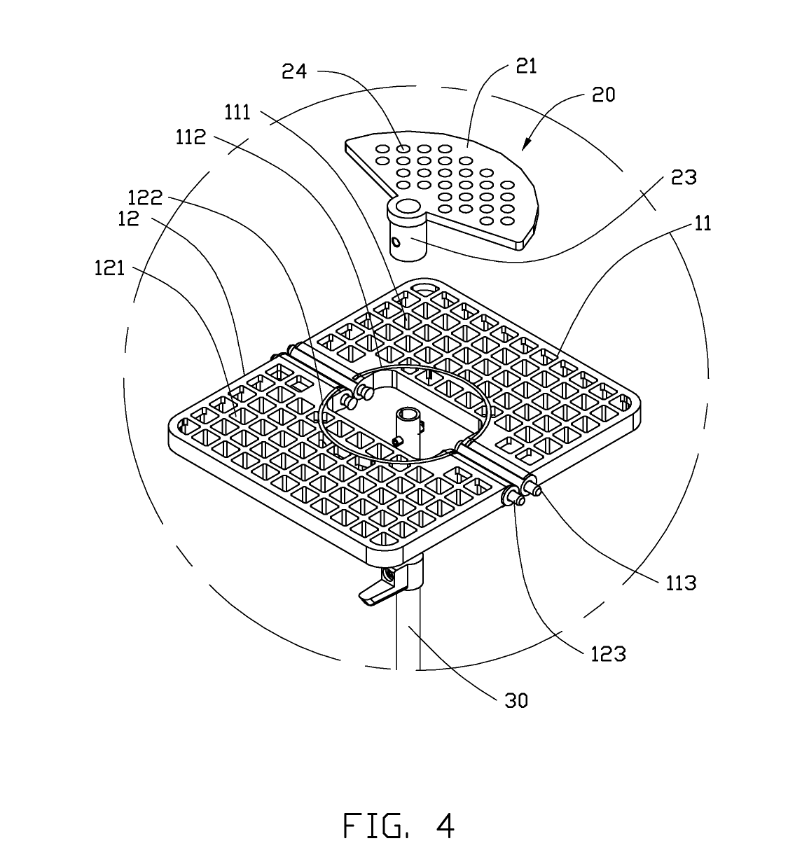

FIGS. 1, 3, and 4 show that the first base 11 defines a plurality of first through holes 111 and the second base 12 defines a plurality of second through holes 121. The first through holes 111 and the plurality of second through holes 121 facilitate air convection through the first base 11 and the second base 12.

A first arc-shaped protrusion 112 extends from a bottom surface of the first base 11. A second arc-shaped protrusion 122 extends from a bottom surface of the second base 12. Each of the first arc-shaped protrusion 112 and the second arc-shaped protrusion 122 is substantially a semicircle. A diameter of each of the first arc-shaped protrusion 112 and the second arc-shaped protrusion 122 is smaller than a radius of either the support plate 21 or the arc-shaped boss 22.

Two pairs of first pivoting posts 113 are located on the first base 11. Each pair of first pivoting posts 113 corresponds to a pair of first pivoting holes 134 of a pair of first pivoting pieces 133. Two pairs of second pivoting posts 123 are located on the second base 12. Each pair of second pivoting posts 123 corresponds to a pair of second pivoting holes 154 of a pair of second pivoting pieces 153.

The shaft 30 secures a plurality of jacking members 31. Each jacking member 31 extends along a direction substantially perpendicular to an axial direction of the shaft 30.

Each blocking plate 50 includes a plate body 51 and two positioning portions 52 extending from an end of the plate body 51. Each positioning portion 52 defines a through hole 521.

The dispensing device further includes a plurality of bolts 60. Each bolt 60 includes an inserting portion 61 and a blocking portion 63. In one embodiment, a cross section of the blocking portion 63 is circular, and the through hole 521 is circular. A diameter of the blocking portion 63 is smaller than a diameter of the through hole 521.

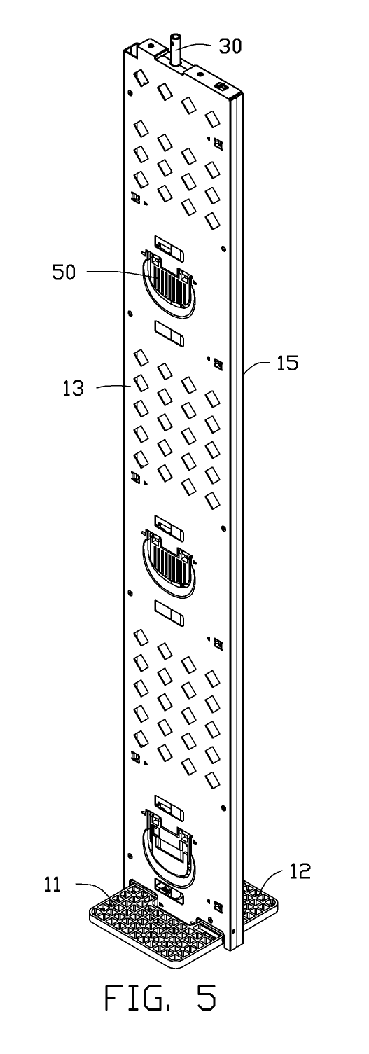

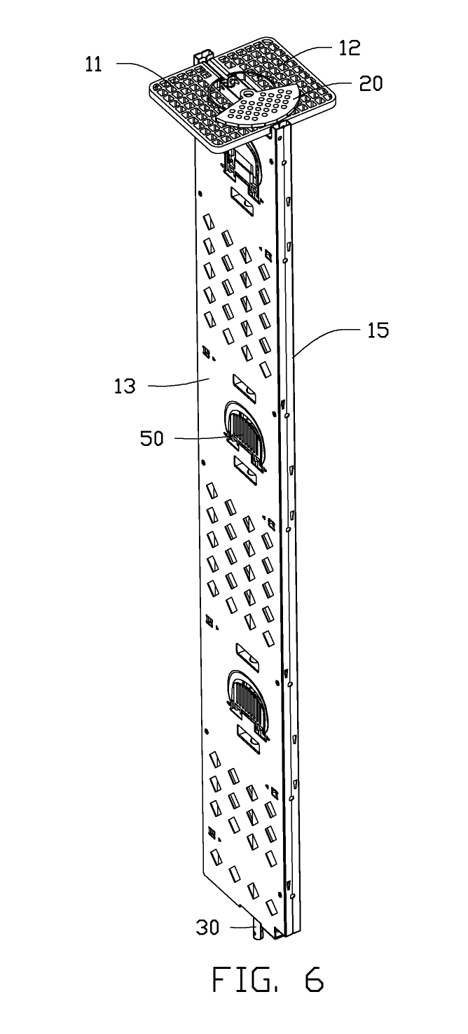

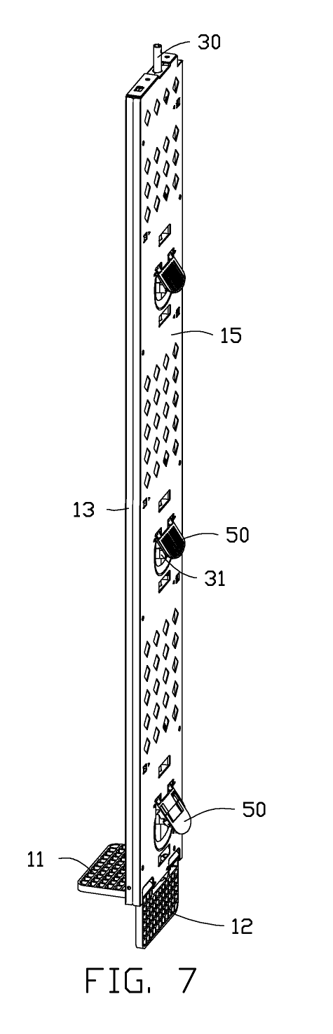

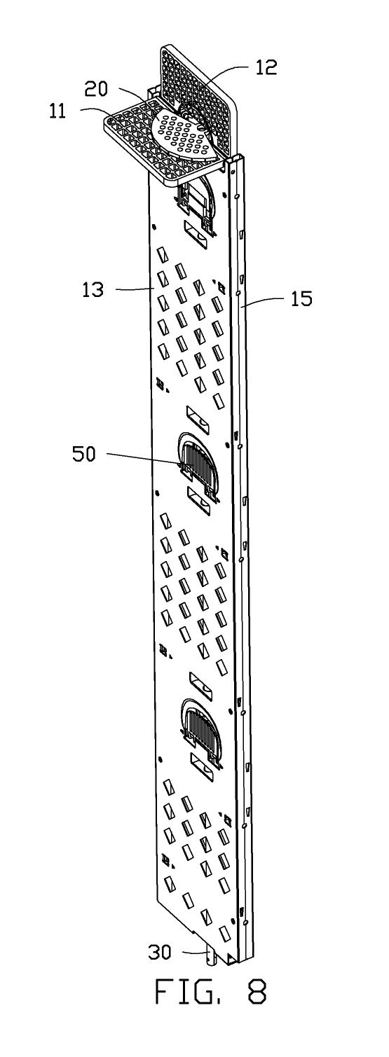

FIGS. 5-8 show that in assembly of the blocking plate 50 to the first plate 131, the blocking plate 50 is placed in the opening 135, and the positioning portion 52 is located in the pair of the first positioning pieces 136. The inserting portion 61 is inserted through the first positioning hole 1361 and the through hole 521 until the blocking portion 63 is blocked by the first protrusion 137. The bolt 60 is slid to elastically deform the first mounting plate 131, causing the blocking portion 63 slide over the first protrusion 137 and is mounted between the first protrusion 137 and the first positioning piece 136. The protrusion 137 prevents the bolt 60 from disengaging from the first positioning piece 136. The blocking plate 50 is mounted to the second mounting plate 151 with the same process in the first mounting plate 131. The first pivoting posts 113 of the first base 11 are received in the first pivoting holes 134 of the first pivoting pieces 133. The first base 11 is rotatably mounted to the first frame 13. The first base 11 is rotatable about a first horizontal axis. The second pivoting posts 123 of the second base 12 are received in the second pivoting holes 154 of the second pivoting pieces 153. The second base 12 is rotatably mounted to the second frame 15. The second base is rotatable about a second horizontal axis. The shaft 30 is placed between the first frame 13 and the second frame 15 and is aligned with the first cutout 1321 and the second cutout 1521. The first frame 13 is secured to the second frame 15 by screws (not shown). The first cutout 1321 and the second cutout 1521 form a circular receiving hole for receiving the shaft 30. The shaft 30 is connected to a motor (not shown), which rotates the shaft 30. Tray 20 is located under the first base 11 and the second base 12. The mounting post 23 surrounds a bottom end of the shaft 30 and is rotatable together with the shaft 30.

In use, the product (not shown) is placed on the first base 11 and the second base 12. The shaft 30 is rotatable between an initial position and a first position. The shaft 30 is further rotatable between the initial position and a second position. When the shaft 30 is in the initial position, the jacking members 31 are between the first mounting plate 131 and the second mounting plate 151. The plate body 51 is received in the first opening 135 or the second opening 155. In addition, the tray 20 holds the first base 11 and the second base 12, to prevent the first base 11 and the second base 12 from rotating relative to the first frame 13 and a second frame 15. The upper surface of the support plate 21 contacts and supports both the first arc-shaped protrusion 112 of the first base 11 and the second arc-shaped protrusion 122 of the second base 12. The arc-shaped boss 22 of the support plate 21 contacts and supports both the bottom surface of the first base 11 and the bottom surface of the second base 12. Thus, the product cannot drop down from either the first base 11 or the second base 12.

When the shaft 30 is in the first position, the tray 20 is rotated over the second base 12 and completely holds the first base 11. At the same time, the jacking member 31 extends out of the first opening 135 and jacks the blocking plates 50 from the first mounting plate 131. In this position, the product on the second base 12 is rotatable relative to the shaft 30 to drop down the second base 12, allowing the product to be purchased. The blocking plate 50 extends out of the first opening 135 to hold the product to remain on the second base 12.

When the shaft 30 is in the second position, the tray 20 is rotated over the first base 11 and completely holds the second base 12. At the same time, the jacking member 31 extends out of the second opening 155 and jacks the blocking plates 50 from the second mounting plate 151. In this position, the product on the first base 12 is rotatable relative to the shaft 30 under the action of gravity to drop down the first base 11, allowing the product to be purchased. The blocking plate 50 extends out of the second opening 155 to hold the product to remain on the first base 11.

When the product is being showed and not being purchased, the shaft 30 is in the initial position. When the product is purchased, the motor drives the shaft 30 to rotate to the first position or the second position, allowing the product to drop down from the first base 11 or the second base 12. Then the motor drives the shaft 30 to rotate to the initial position, causing the tray 20 to rotate the first base 11 or the second base 12 upwards, until the tray 20 holds the first base 11 and the second base 12. The product is then prevented to drop down.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A dispensing assembly, comprising:
a bracket;
a base rotatably mounted to the bracket and configured to accommodate sales items thereon, the base being rotatable about a horizontal axis;
a tray located beneath the base, the tray being rotatable about a vertical axis;
wherein when the tray is rotated about the vertical axis to a first position, the tray supports the base thereby preventing the sales item from dropping down from the base, when the tray is rotated about the vertical axis to a second position, the tray releases the base, allowing the base to rotate about the horizontal axis and releasing the sales items to drop down from the base.

2. The dispensing assembly of claim 1, wherein an arc-shaped protrusion protrudes from a bottom surface of the base, when the tray is rotated about the vertical axis to the first position, an upper surface of the tray abuts the arc-shaped protrusion.

3. The dispensing assembly of claim 2, wherein the arc-shaped protrusion is substantially a semicircle.

4. The dispensing assembly of claim 1, wherein an arc-shaped boss protrudes from an upper surface of the tray, when the tray is rotated about the vertical axis to the first position, the arc-shaped boss abuts a bottom surface of the base.

5. The dispensing assembly of claim 1, wherein the base defines a plurality of through holes.

6. The dispensing assembly of claim 1, wherein the tray defines a plurality of convective orifices.

7. The dispensing assembly of claim 1, wherein the tray is substantially a circular sector.

8. The dispensing assembly of claim 7, wherein a central angle of the tray is smaller than 180 degrees.

9. The dispensing assembly of claim 7, wherein an arc of the tray is formed with a plurality of sides of a regular polygon.

10. The dispensing assembly of claim 1, further comprising a shaft rotatably received in the bracket, wherein the tray is secured to the shaft.

11. A dispensing assembly, comprising:
a bracket;
a first base and a second base both rotatably mounted to the bracket, each of the first base and the second base being configured to accommodate sales items thereon and rotatable about a horizontal axis;
a tray located beneath the first base and the second base, the tray being rotatable about a vertical axis;
wherein when the tray is rotated about the vertical axis to an initial position, the tray supports both the first base and the second base and prevents the product from dropping down from either the first base or the second base, when the tray is rotated about the vertical axis to a first position, the tray supports the first base and releases the second base, allowing the second base to rotate about the horizontal axis and releasing the sales items to drop down from the second base, when the tray is rotated about the vertical axis to a second position, the tray supports the second base and releases the first base, allowing the first base to rotate about the horizontal axis and releasing the sales items to drop down from the first base.

12. The dispensing assembly of claim 11, wherein a first arc-shaped protrusion protrudes from a bottom surface of the first base, a second arc-shaped protrusion protrudes from a bottom surface of the second base, when the tray is rotated about the vertical axis to the initial position, an upper surface of the tray abuts both the first arc-shaped protrusion and the second arc-shaped protrusion.

13. The dispensing assembly of claim 12, wherein each of the first arc-shaped protrusion and the second arc-shaped protrusion is substantially a semicircle.

14. The dispensing assembly of claim 11, wherein an arc-shaped boss protrudes from an upper surface of the tray, when the tray is rotated about the vertical axis to the initial position, the arc-shaped bottom abuts both a bottom surface of the first base and a bottom surface of the second base.

15. The dispensing assembly of claim 11, wherein each of the first base and the second base defines a plurality of through holes.

16. The dispensing assembly of claim 11, wherein the tray defines a plurality of convective orifices.

17. The dispensing assembly of claim 11, wherein the tray is substantially a circular sector.

18. The dispensing assembly of claim 17, wherein a central angle of the tray is smaller than 180 degrees.

19. The dispensing assembly of claim 17, wherein an arc of the tray is formed with a plurality of sides of a regular polygon.

20. The dispensing assembly of claim 11, further comprising a shaft rotatably received in the bracket, wherein the tray is secured to the shaft.
